(19) United States
(12) Patent Application Publication
(10) Pub. No.: US 2026/0044294 A1
(43) Pub. Date: Feb. 12, 2026

(54) ELECTRONIC DEVICE, METHOD OF CONTROLING AN ELECTRONIC DEVICE

(71) Applicant: SHARP KABUSHIKI KAISHA, Osaka (JP)

(72) Inventor: Kazunori HASEGAWA, Osaka (JP)

(21) Appl. No.: 19/293,411

(22) Filed: Aug. 7, 2025

(30) Foreign Application Priority Data
Aug. 7, 2024 (JP) 2024-131120

(51) Int. Cl. G06F 3/12

(52) U.S. Cl. CPC G06F 3/123; G06F 3/1205; G06F 3/1222; G06F 3/1238

(57) ABSTRACT

An electronic device, the electronic device including an installer that executes an installation process of the printer driver, a communicator that transmits and receives various data by communicating with an image forming apparatus compatible with the printer driver via a network, a protected print mode setter that receives a setting of whether a predetermined protected print mode is to be enabled, a storage that stores the setting, a display that displays various types of information to a user, a controller that controls the installer, the communicator, the protected print mode setter, the storage, and the display. When the installer is started, the controller determines whether the protected print mode is enabled, and when the protected print mode is enabled, the controller causes the display to display a message indicating that the printer driver provided by a third party cannot be installed or started because the protected print mode is enabled.

### FIELD

The disclosure relates to an electronic device, a control method of an electronic device, and more specifically, to an electronic device with built-in software capable of installing an external printer driver for printing on a digital multifunction apparatus, a control method of the electronic device.

### BACKGROUND ART

In the related art, a function has been used to download and install an external printer driver for printing on a digital multifunction apparatus from a server or the like to an electronic device such as a personal computer (PC) or a tablet terminal via a network.

In relation to such a technology, in the related art, in order to avoid troubles and mistakes that arise when each client user makes various settings for the printer driver, a printer driver has been known that has a means for saving initial parameter settings in a system at the time of installation, a means for operating depending on the saved parameters, a means for saving parameter changes made by a user, a means for processing parameter change requests made by external programs, a means for an installer to install the printer driver, and a means for customizing parameter data used by the printer driver by issuing a change request to the printer driver.

### SUMMARY

### Technical Problem

Since Windows printing systems are often targeted by attackers using malware such as Stuxnet and PrintNightmare, Windows Protected Print Mode (WPP) has been introduced in Windows 11 24H2, (Build 26016) in order to improve security.

When WPP is enabled, a vendor-provided printer driver provided by a third party cannot be used, and only an OS standard IPP class driver can be used.

In this case, even when the user installs the vendor-provided printer driver, the user may not be able to use the printer driver, and even when the printer driver is installed, the user may not be able to start the printer driver.

In this case, the user needs to check the reason why the printer driver cannot be installed or started, which makes the introduction of a printing environment more difficult and less convenient for the user.

The disclosure has been made in consideration of the above circumstances, and an object of the disclosure is to provide an electronic device that prevents a decrease in user convenience, such as the inability to install or start a printer driver, when a protected print mode is enabled, and a control method of the electronic device.

### Solution to Problem

According to the disclosure, provided is an electronic device with built-in software capable of installing a printer driver, the electronic device including an installer that executes an installation process of the printer driver, a communicator that transmits and receives various data by communicating with an image forming apparatus compatible with the printer driver via a network, a protected print mode setter that receives a setting of whether a protected print mode predetermined is to be enabled, a storage that stores the setting, a display that displays various types of information to a user, a controller that controls the installer, the communicator, the protected print mode setter, the storage, and the display. In a case where the installer is started, the controller determines whether the protected print mode is enabled, and in a case where the protected print mode is enabled, the controller causes the display to display a message indicating that an installation or start of the printer driver provided by a third party is not possible because the protected print mode is enabled. According to the disclosure, provided is a method of controlling an electronic device with built-in software capable of installing a printer driver, the method including transmitting and receiving various data by communicating with an image forming apparatus compatible with the printer driver via a network, executing an installation process of the printer driver, receiving a setting of whether a protected print mode predetermined is to be enabled, storing the setting, and displaying various types of information to a user. In a case where the installation process of the printer driver is executed in the executing the installation process, the electronic device determines whether the protected print mode is enabled, and in a case where the protected print mode is enabled, the electronic device displays a message indicating that an installation or startup of the printer driver provided by a third party is not possible because the protected print mode is enabled, in the displaying. According to the disclosure, provided is a program for controlling an electronic device with built-in software capable of installing a printer driver in a processor of the electronic device, the program including transmitting and receiving various data by communicating with an image forming apparatus compatible with the printer driver via a network, executing an installation process of the printer driver, receiving a setting of whether a protected print mode predetermined is to be enabled, storing the setting, and displaying various types of information to a user. In a case where the installation process of the printer driver is executed in the executing the installation process, the electronic device determines whether the protected print mode is enabled, and in a case where the protected print mode is enabled, the electronic device displays a message indicating that an installation or startup of the printer driver provided by a third party is not possible because the protected print mode is enabled, in the displaying.

### Advantageous Effects of Disclosure

According to the disclosure, when installing a printer driver, the electronic device determines whether the protected print mode is enabled, and when the protected print mode is enabled, the electronic device displays a message indicating that a printer driver provided by a third party cannot be installed or started, thereby achieving an electronic device, a control method of the electronic device, and a control program for the electronic device that are more convenient for a user than ever before.

### BRIEF DESCRIPTION OF THE DRAWINGS

FIG. 1 is an explanatory diagram illustrating a schematic configuration of an image forming system including a user terminal according to the disclosure.

FIG. 2 is a block diagram illustrating a schematic configuration of a digital multifunction apparatus illustrated in FIG. 1.

FIG. 3 is a block diagram illustrating a schematic configuration of the user terminal illustrated in FIG. 1.

FIG. 4 is a flowchart illustrating an example of a printer driver installation process in an electronic device illustrated in FIG. 1.

FIG. 5 is an explanatory diagram illustrating an example of an information message displayed on a display of the user terminal illustrated in FIG. 1.

FIG. 6 is an example of a printer driver setting flag stored in a storage of the user terminal illustrated in FIG. 1.

FIG. 7 is an example of a printer driver installation completion message displayed on the display of the user terminal illustrated in FIG. 1.

FIG. 8 is a flowchart illustrating an example of a printer driver selection process in the user terminal illustrated in FIG. 1.

FIG. 9 is an explanatory diagram illustrating an example of a printer driver selection screen displayed on the display of the user terminal illustrated in FIG. 1.

FIG. 10 is an explanatory diagram illustrating an example of a screen for functional differences of printer drivers displayed on the display of the user terminal illustrated in FIG. 1.

FIG. 11 is a flowchart illustrating an example of a printer driver installation process in the user terminal illustrated in FIG. 1.

FIG. 12 is a flowchart illustrating an example of an IPP class driver installation process in the user terminal illustrated in FIG. 1.

FIG. 13 is an explanatory diagram illustrating an example of candidate models for PSA, which are displayed on the display of the user terminal illustrated in FIG. 1.

FIG. 14 is an explanatory diagram illustrating an example of all candidate models for PSA, which are displayed on the display of the user terminal illustrated in FIG. 1.

FIG. 15 is a flowchart illustrating an example of a vendor-provided driver installation process in the user terminal illustrated in FIG. 1.

FIG. 16 is an explanatory diagram illustrating an example of candidate models for installing a vendor-provided driver, which are displayed on the display of the user terminal illustrated in FIG. 1.

### DESCRIPTION OF EMBODIMENTS

In the disclosure, an “image forming apparatus” is an apparatus that forms and outputs an image, such as a copier having a copying function, such as a printer that uses an electrophotographic method for forming an image with toner, or a multifunction peripheral (MFP) also having functions other than copying.

Regarding “install a printer driver”, the printer driver may be downloaded from an external server or the like and installed, or the printer driver obtained via a USB flash drive or the like may be installed.

Further, preferred aspects of the disclosure will be described.

The electronic device according to the disclosure may further include an operation acceptor that receives operation by a user. The controller, in the case where the protected print mode is enabled, may cause the display to display a message indicating that the protected print mode is to be disabled in order to install and start the printer driver provided by the third party, and a setting screen to disable the protected print mode. The operation acceptor may receive operation by the user to disable the protected print mode.

In this way, in the case where the protected print mode is enabled when the printer driver is installed, a message is displayed indicating that the protected print mode is to be disabled in order to install and start a printer driver provided by the third party, and a setting screen for disabling the protected print mode is displayed, and the operation by the user is received, thereby achieving an electronic device that is more user-friendly than before.

In the electronic device according to the disclosure, the controller, in the case where the protected print mode is enabled, may not permit installation or startup of the printer driver provided by the third party.

In this way, in the case where the protected print mode is enabled when the printer driver is installed, the installation and startup of the printer driver are not permitted, thereby achieving an electronic device that is more convenient for the user than ever before.

In the electronic device according to the disclosure, the controller, in a case where the protected print mode is disabled, may cause the display to display a selection screen of the installable printer driver.

In this way, in the case where the protected print mode is disabled when the printer driver is installed, the selection screen of the installable driver is displayed, thereby achieving an electronic device that is more convenient for the user than ever before.

In the electronic device according to the disclosure, the controller, in the case where the protected print mode is disabled, may cause the display to display both the printer driver provided by the third party and an IPP class driver as selectable on the selection screen.

In this way, in the case where the protected print mode is disabled when the printer driver is installed, the screen for selecting the printer driver to be installed displays both the printer driver provided by the third party and the IPP class driver as selectable, thereby achieving an electronic device that is more convenient for the user than ever before.

In the electronic device according to the disclosure, the controller, in the case where the protected print mode is disabled and a plurality of the installable printer drivers are present on the selection screen, may cause the display to display a difference in function of the plurality of the installable printer drivers.

In this way, in the case where the protected print mode is disabled when the printer driver is installed and the multiple printer drivers that are installable are displayed on the selection screen, the difference in function of the multiple printer drivers is displayed, thereby achieving an electronic device that is more convenient for the user than ever before.

Hereinafter, the disclosure will be described in further detail using the drawings. Note that the following description is in all aspects illustrative and it should not be understood as limiting the disclosure.

### First Embodiment

### Schematic Configuration of Image Forming System 100

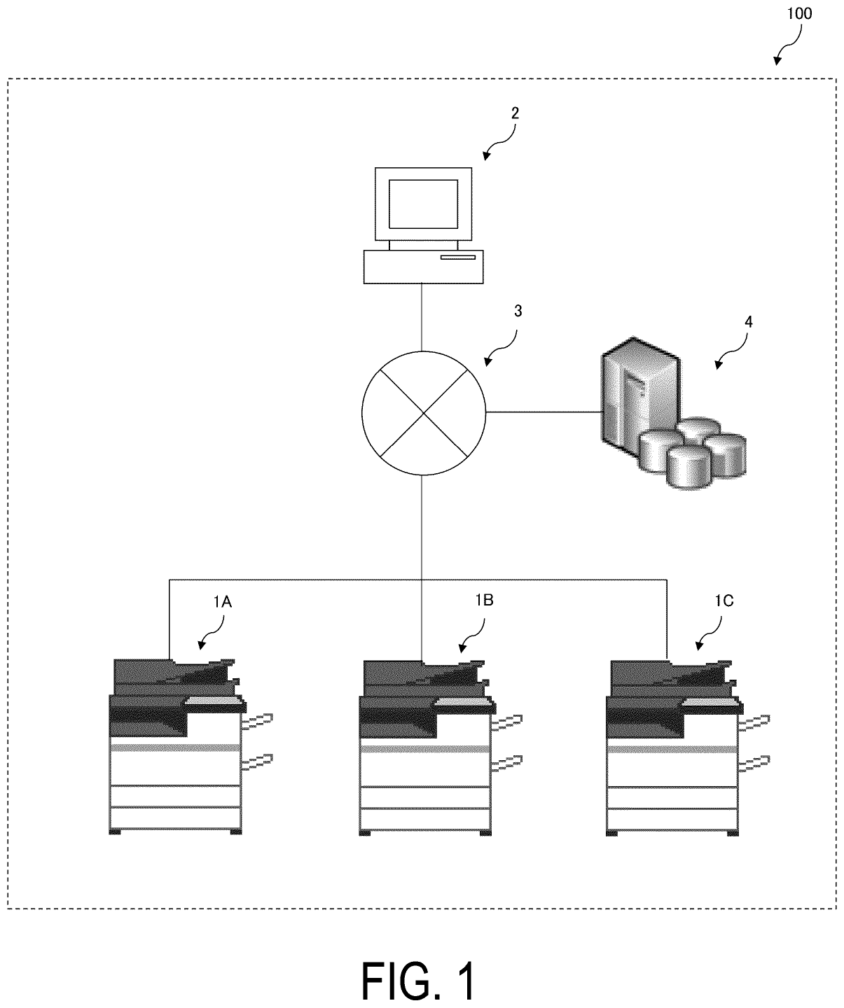

A configuration of an image forming system 100 including a user terminal 2 as an example of an electronic device according to the disclosure will be described with reference to FIG. 1.

The disclosure can be applied not only to PCs, but also to all types of electronic devices that have built-in software or an OS that can install programs, such as smartphones, tablet terminals, and electronic blackboards.

FIG. 1 is an explanatory diagram illustrating a schematic configuration of the image forming system 100 including the user terminal 2 according to the disclosure.

As illustrated in FIG. 1, the image forming system 100 includes digital multifunction apparatuses 1A, 1B, and 1C (hereinafter collectively referred to as a multifunction apparatus 1), the user terminal 2, and a server 4, which are connected to one another via a network 3.

The digital multifunction apparatus 1 is an apparatus that receives a print job from the user terminal 2 and outputs an image.

The user terminal 2 is a terminal that downloads a printer driver for printing on the digital multifunction apparatus 1 from the server 4, installs the printer driver, and transmits a print job to the digital multifunction apparatus 1.

The network 3 is a network such as a LAN or a dedicated communication line that connects the digital multifunction apparatuses 1A, 1B, and 1C and the user terminal 2, and may be wired or wireless.

The server 4 provides a printer driver for printing on the digital multifunction apparatus 1 to the user terminal 2.

### Schematic Configuration of Digital Multifunction Apparatus 1

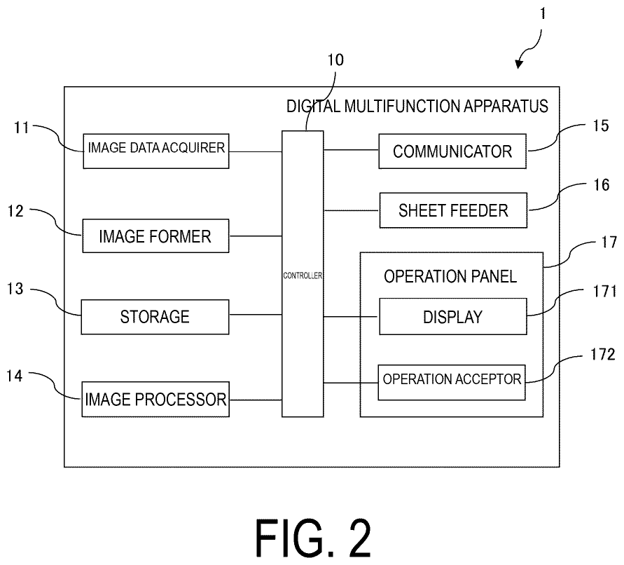

Next, a schematic configuration of the digital multifunction apparatus 1 will be described with reference to FIG. 2.

FIG. 2 is a block diagram illustrating the schematic configuration of the digital multifunction apparatus 1 illustrated in FIG. 1.

As illustrated in FIG. 2, the digital multifunction apparatus 1 includes a controller 10, an image data acquirer 11, an image former 12, a storage 13, an image processor 14, a communicator 15, a sheet feeder 16, and an operation panel 17.

Hereinafter, each component of the digital multifunction apparatus 1 will be described.

The controller 10 collectively controls the digital multifunction apparatus 1 and includes at least one central processing unit (CPU), at least one random access memory (RAM), at least one read only memory (ROM), and various interface circuits.

The controller 10 monitors and controls all loads such as detection of each sensor, a motor, a clutch, and the operation panel 17 in order to control overall operation of the digital multifunction apparatus 1.

The image data acquirer 11 acquires image data received from the user terminal 2 via the network 3.

The image data acquirer 11 detects and reads a document placed on a document table or a document conveyed from a document tray, and generates image data.

The image former 12 prints out, onto a sheet, image data acquired by the image data acquirer 11 and processed by the image processor 14.

The storage 13 is an element or a storage medium that stores information to be used to enable various functions of the digital multifunction apparatus 1, control programs, and the like. For example, a semiconductor device such as a RAM or a ROM or a storage medium such as a hard disk, a flash storage, or a solid state drive (SSD) is used.

Note that the program and the data may be stored in different devices, such as by configuring an area for storing data in a hard disk drive and an area for storing programs in a flash storage.

The image processor 14 converts image data input from the image data acquirer 11 into an appropriate electrical signal based on analysis results of commands for jobs such as printing obtained from the user terminal 2 or the like, or commands for jobs such as printing input from an operation acceptor 172, and processes the signal according to output requests such as enlargement or reduction.

The communicator 15 communicates with external devices such as the user terminal 2 via the network 3, and transmits and receives data or the like to and from these external devices.

The sheet feeder 16 includes sheet feeding cassettes and a manual feed tray, and conveys sheets stored therein to the image former 12.

Note that sheets are stored in different sheet feeding cassettes, depending on the size and type of the sheet.

The operation panel 17 is composed of a display panel composed of a liquid crystal panel or the like, and a touch panel, such as a capacitive touch panel, that is placed on top of the display panel and detects a position touched with a finger, and includes a display 171 and the operation acceptor 172.

The display 171 displays various types of information.

The display 171 is composed of, for example, a CRT display, a liquid crystal display, or an EL display, and is a display device such as a monitor or a line display used by an operating system and application software to display electronic data such as processing status.

The controller 10 displays the operation and status of the digital multifunction apparatus 1 through the display 171.

The operation acceptor 172 is an interface for operating the digital multifunction apparatus 1 and receives commands from the user.

The operation acceptor 172 does not need to be operated only by a touch panel, and part or the whole of the operation acceptor 172 may be configured with physical keys independent of the display 171.

### Schematic Configuration of User Terminal 2

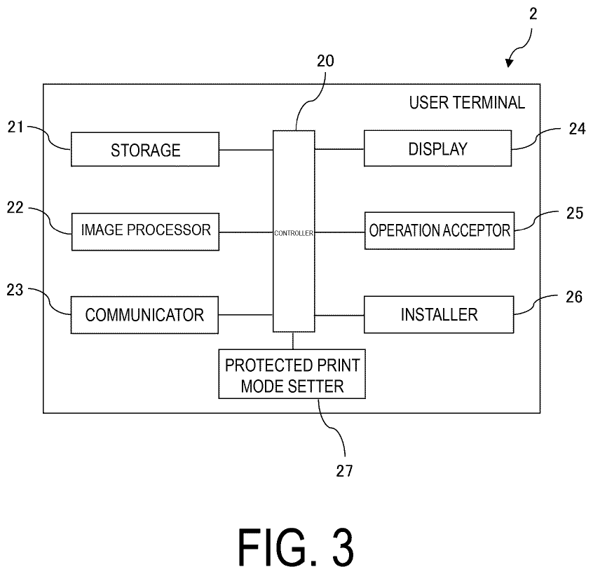

Next, a schematic configuration of the user terminal 2 will be described based on FIG. 3. FIG. 3 is a block diagram illustrating a schematic configuration of the user terminal 2 illustrated in FIG. 1.

As illustrated in FIG. 3, the user terminal 2 according to the disclosure includes a controller 20, a storage 21, an image processor 22, a communicator 23, a display 24, an operation acceptor 25, an installer 26, and a protected print mode setter 27.

The controller 20 collectively controls the user terminal 2 and includes a CPU, a RAM, a ROM, various interface circuits, and the like.

The storage 21 is an element or a storage medium that stores information to be used to enable various functions of the user terminal 2, control programs, and the like. For example, a semiconductor device such as a RAM or a ROM or a storage medium such as a hard disk, a flash storage, or an SSD is used.

The storage 21 stores data related to a printer driver.

The image processor 22 converts the image data to be displayed on the display 24 into an appropriate electrical signal based on an operation instruction from the operation acceptor 25, and processes the signal according to output requests such as enlargement or reduction.

The communicator 23 communicates with the digital multifunction apparatus 1 via the network 3 and transmits and receives data.

The display 24 displays various types of information on the user terminal 2.

The operation acceptor 25 is an interface for operating the user terminal 2 and receives commands from the user.

The installer 26 installs a printer driver for the digital multifunction apparatus 1.

The protected print mode setter 27 sets whether a predetermined protected print mode is to be enabled or disabled. When the protected print mode is enabled, a third party-provided printer driver cannot be used, and only an OS standard IPP class driver can be used.

### Procedure of Printer Driver Installation Process in User Terminal 2

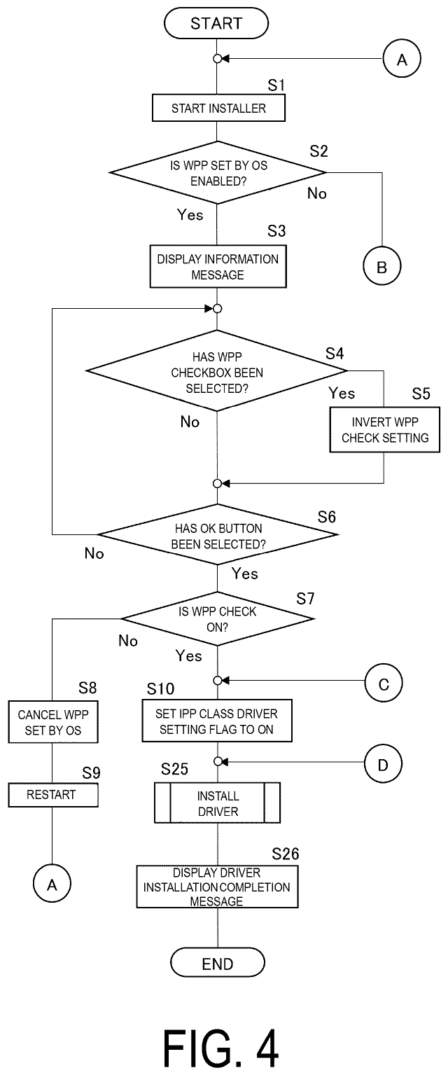

Next, a procedure of a printer driver installation process in the user terminal 2 according to the disclosure will be described with reference to FIG. 4.

In the first embodiment of the disclosure, it is assumed that a printer driver for printing on the digital multifunction apparatus 1 is downloaded from the server 4 and installed by the installer 26 that has been downloaded in advance to the user terminal 2.

The same applies when a printer driver for printing on the multifunction apparatus 1 is acquired from a USB flash drive or the like (not illustrated) and installed.

FIG. 4 is a flowchart illustrating an example of the printer driver installation process in the user terminal 2 illustrated in FIG. 1.

In step S1 in FIG. 4, the controller 20 of the user terminal 2 starts the installer 26 that has been downloaded in advance (step S1).

Subsequently, in step S2, the controller 20 determines whether WPP set by the OS is enabled (step S2).

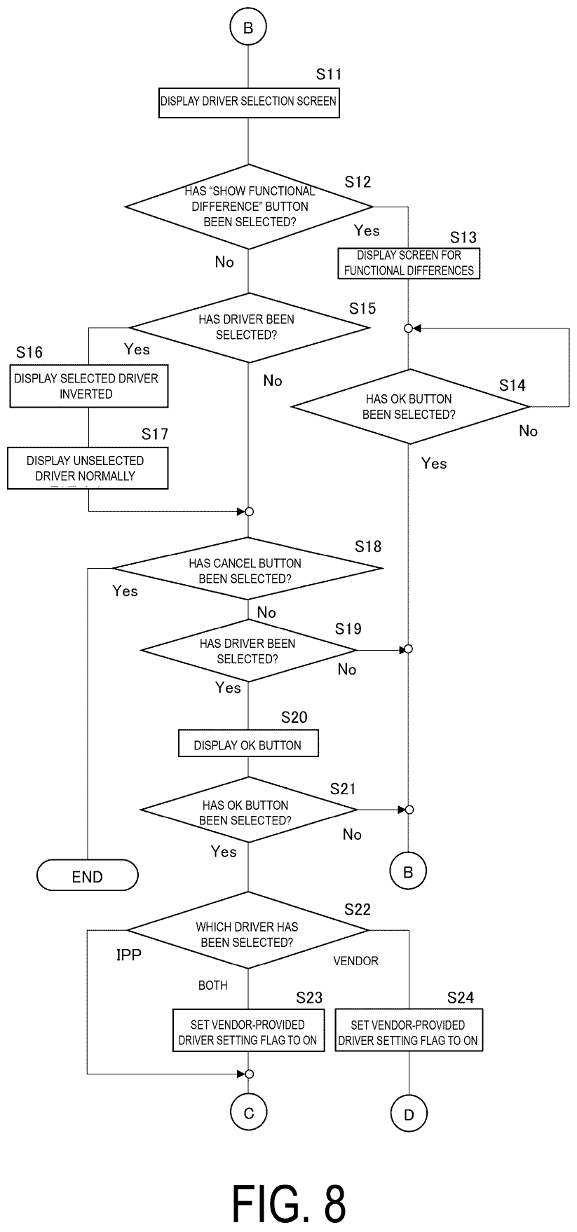

If WPP set by the OS is not enabled (if the determination in step S2 is No), the controller 20 executes the processing in step S11 in FIG. 8 (described below).

On the other hand, if WPP set by the OS is enabled (if the determination in step S2 is Yes), in step S3, the controller 20 causes the display 24 to display a predetermined information message indicating the setting status of WPP (step S3).

This information message includes such as, for example, that WPP is enabled, that the vendor-provided driver cannot be installed, that even if the vendor-provided driver can be installed, the vendor-provided driver may not start, and that WPP is to be disabled to install the vendor-provided driver.

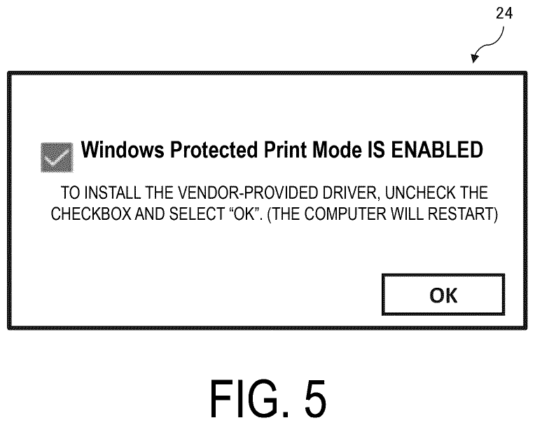

FIG. 5 is an explanatory diagram illustrating an example of the information message displayed on the display 24 of the user terminal 2 illustrated in FIG. 1.

As illustrated in FIG. 5, a title “Windows Protected Print Mode is enabled” is displayed on the display 24 along with a checkbox. In addition, a message “to install the vendor-provided driver, uncheck the checkbox and select ”OK“ (the computer will restart)” along with an “OK”button is displayed.

When the user wants to install the vendor-provided driver, the user unchecks the checkbox and then selects the “OK”button.

Subsequently, in step S4 in FIG. 4, the controller 20 determines whether the WPP checkbox has been selected (step S4).

If the WPP checkbox has been selected (if the determination in step S4 is Yes), in step S5, the controller 20 inverts the WPP check setting (step S5).

That is, the controller 20 changes the state of the WPP checkbox to OFF when the state is ON, and changes the state of the WPP checkbox to ON when the state is OFF. Thereafter, the controller 20 makes a determination in step S6.

On the other hand, if the WPP checkbox has not been selected (if the determination in step S4 is No), in step S6, the controller 20 determines whether the “OK” button has been selected (step S6).

If the OK button has not been selected (if the determination in step S6 is No), the controller 20 returns the processing to the determination in step S4.

On the other hand, if the “OK” button has been selected (if the determination in step S6 is Yes), in step S7, the controller 20 determines whether the WPP check is ON (step S7).

If the WPP check is not ON (if the determination in step S7 is No), in step S8, the controller 20 cancels WPP set by the OS (step S8).

At this time, the controller 20 may cause the display 24 to display a setting procedure for canceling WPP set by the OS.

In subsequent step S9, the controller 20 executes a restart in order to cancel WPP set by the OS (step S9), and then returns the processing to step S1.

On the other hand, if the WPP check is ON (if the determination in step S7 is Yes), in step S10, the controller 20 sets an IPP class driver setting flag to ON in preparation for installation of the IPP class driver (step S10).

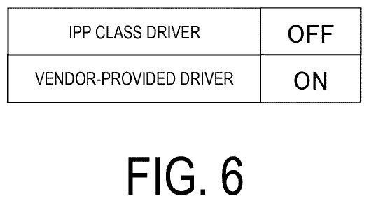

FIG. 6 is an example of a printer driver setting flag stored in the storage 21 of the user terminal 2 illustrated in FIG. 1.

In the example in FIG. 6, the IPP class driver is set to “OFF”, and the vendor-provided driver is set to “ON”.

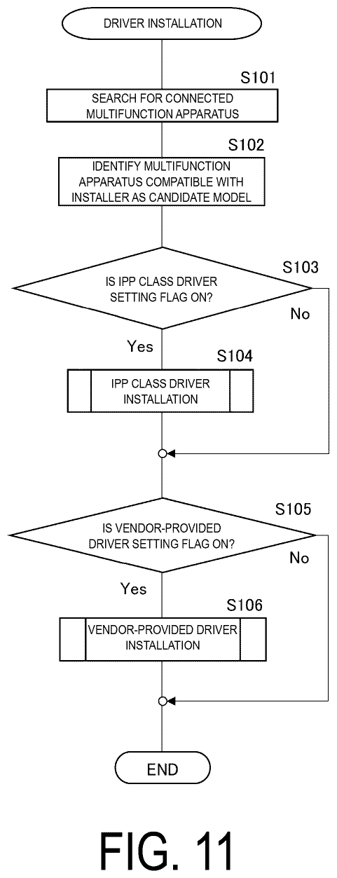

Thereafter, in step S25 in FIG. 4, the controller 20 executes installation of the printer driver (step S25). Note that details of the printer driver installation process will be described below in the description of steps S101 to S106 in FIG. 11.

When the installation of the printer driver is completed, in step S26, the controller 20 causes the display 24 to display a printer driver installation completion message (step S26), and then ends the process.

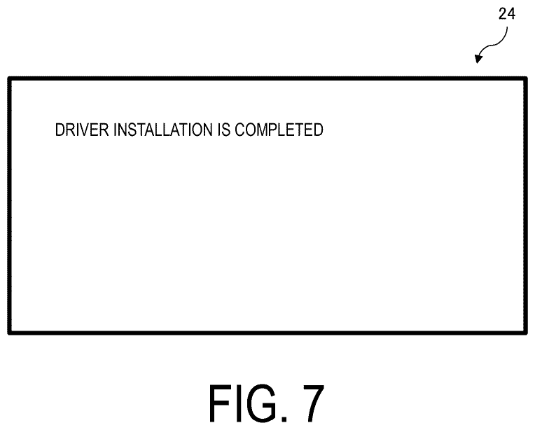

FIG. 7 is an example of the printer driver installation completion message displayed on the display 24 of the user terminal 2 illustrated in FIG. 1.

As illustrated in FIG. 7, the message “driver installation is completed” is displayed on the display 24.

### Procedure of Printer Driver Selection Process in User Terminal 2

Next, a procedure of a printer driver selection process in the user terminal 2 will be described with reference to FIGS. 8 to 10.

FIG. 8 is a flowchart illustrating an example of the printer driver selection process in the user terminal 2 illustrated in FIG. 1.

When WPP set by the OS is not enabled, a printer driver is to be installed by the installer 26, so a selection screen for installable printer drivers is displayed to allow the user to select one.

In step S11 in FIG. 8, the controller 20 causes the display 24 to display a predetermined printer driver selection screen (step S11).

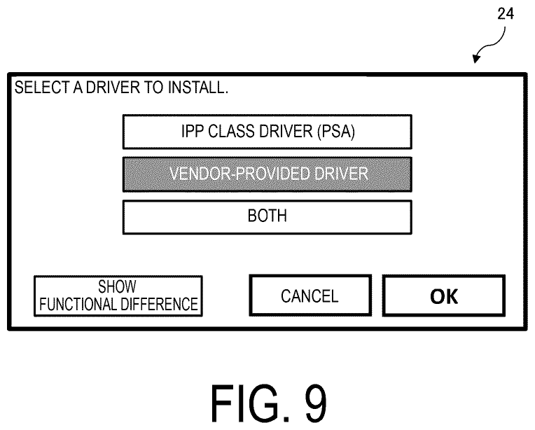

FIG. 9 is an explanatory diagram illustrating an example of the printer driver selection screen displayed on the display 24 of the user terminal 2 illustrated in FIG. 1.

As illustrated in FIG. 9, the display 24 displays a message “select a driver to install” along with options of “IPP class driver (PSA)”, “vendor-provided driver”, and “both”. In the example in FIG. 9, “vendor-provided driver”is selected and displayed inverted.

When the user selects a desired printer driver and then selects an “OK” button, the selected printer driver is installed.

When the user selects a “cancel”button, the printer driver selection process is canceled.

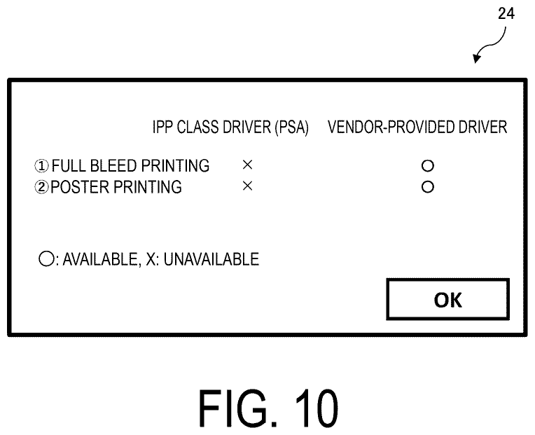

When the user selects a “show functional difference” button, a screen displaying the functional differences between the IPP class driver and the vendor-provided driver (described later with reference to FIG. 10) can be displayed.

Subsequently, in step S12 in FIG. 8, the controller 20 determines whether the “show functional difference”button has been selected (step S12).

If the “show functional difference” button has been selected (if the determination in step S12 is Yes), in step S13, the controller 20 causes the display 24 to display a screen for functional differences that displays details of the functions of both printer drivers in a comparable manner (step S13).

FIG. 10 is an explanatory diagram illustrating an example of the screen for functional differences of the printer drivers displayed on the display 24 of the user terminal 2 illustrated in FIG. 1.

The example in FIG. 10 displays whether (1) full bleed printing and (2) poster printing are available ( [symbol] ) or unavailable (x) for the WPP class driver (PSA) and the vendor-provided driver.

When the user selects an “OK” button at the lower right of the screen for functional differences, the screen for functional differences is cleared and the screen returns to the printer driver selection screen.

Subsequently, in step S14 in FIG. 8, the controller 20 determines whether the “OK” button has been selected (step S14).

If the “OK” button has been selected (if the determination in step S14 is Yes), the controller 20 returns the processing to step S11.

On the other hand, if the “OK” button has not been selected (if the determination in step S14 is No), the controller 20 returns the processing to the determination in step S14.

Subsequently, in step S12, if the “show functional difference” button has not been selected (if the determination in step S12 is No), in step S15, the controller 20 determines whether a printer driver has been selected (step S15).

If the printer driver has not been selected (if the determination in step S15 is No), the controller 20 executes a determination in step S18 (described later).

If the printer driver has been selected (if the determination in step S15 is Yes), in step S16, the selected printer driver is displayed inverted so as to be visually recognized (step S16). Note that the selected printer driver may be surrounded by a frame of a specific color or highlighted so that the selected printer driver can be visually recognized.

In subsequent step S17, the unselected printer driver is displayed normally (step S17). The unselected printer driver may be displayed grayed out.

Subsequently, in step S18, the controller 20 determines whether the “cancel” button has been selected (step S18).

If the “cancel” button has been selected (if the determination in step S18 is Yes), the controller 20 ends the installation of the printer driver.

On the other hand, if the “cancel” button has not been selected (if the determination in step S18 is No), in step S19, the controller 20 determines whether a printer driver has been selected (step S19).

When the printer driver has not been selected (if the determination in step S19 is No), the controller 20 returns the processing to step S11.

On the other hand, if the printer driver has been selected (if the determination in step S19 is Yes), in step S20, the controller 20 causes the display 24 to display an “OK” button (step S20).

In subsequent step S21, the controller 20 determines whether the “OK” button has been selected (step S21).

If the “OK” button has not been selected (if the determination in step S21 is No), the controller 20 returns the processing to step S11.

On the other hand, if the “OK” button has been selected (if the determination in step S21 is Yes), in step S22, the controller 20 determines which printer driver has been selected (step S22).

If the IPP class driver has been selected (if the determination in step S22 is IPP), the controller 20 executes the processing in step S10 in FIG. 4.

If both the IPP class driver and the vendor-provided driver have been selected (if the determination in step S22 is both), in step S23, the controller 20 sets a vendor-provided driver setting flag to ON (step S23). Thereafter, the controller 20 executes the processing in step S10 in FIG. 4.

If the vendor-provided driver has been selected (if the determination in step S22 is vendor), in step S24, the controller 20 sets the vendor-provided driver setting flag to ON (step S24). Thereafter, the controller 20 executes the process in step S25 in FIG. 4.

### Procedure of Printer Driver Installation Process in User Terminal 2

Next, a procedure of the printer driver installation process in the user terminal 2 will be described with reference to FIG. 11.

FIG. 11 is a flowchart illustrating an example of the printer driver installation process in the user terminal 2 illustrated in FIG. 1, and corresponds to the process in step S25 in FIG. 4.

In step S101 in FIG. 11, the controller 20 searches for the digital multifunction apparatus 1 connected via the network 3 (step S101).

Subsequently, in step S102, the controller 20 preferentially identifies the digital multifunction apparatus 1 compatible with the installer 26 as a candidate model (step S102).

Subsequently, in step S103, the controller 20 determines whether the IPP class driver setting flag is ON (step S103).

If the IPP class driver setting flag is ON (if the determination in step S103 is Yes), in step S104, the controller 20 executes an IPP class driver installation process (step S104).

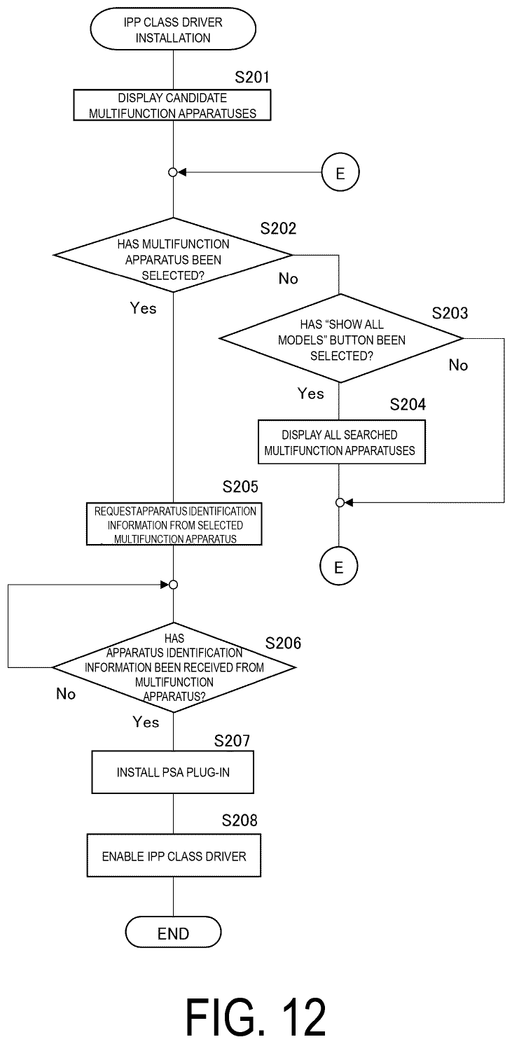

Details of the IPP class driver installation process will be described below in the description of FIG. 12.

On the other hand, if the IPP class driver setting flag is OFF (if the determination in step S103 is No), in step S105, the controller 20 determines whether the vendor-provided driver setting flag is ON (step S105).

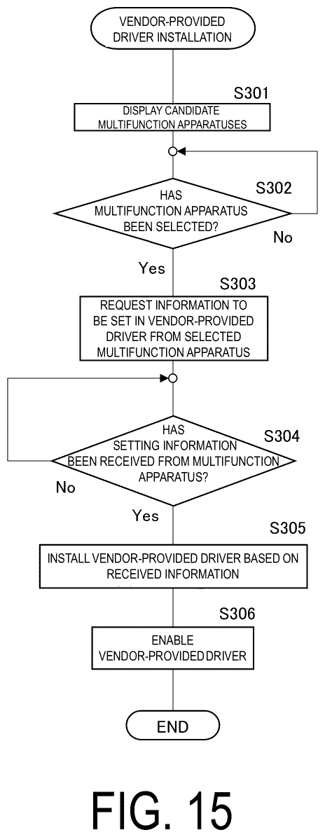

If the vendor-provided driver setting flag is ON (if the determination in step S105 is Yes), in step S106, the controller 20 executes a vendor-provided driver installation process (step S106). Details of the vendor-provided driver installation process will be described below in the description of FIG. 15.

On the other hand, if the vendor-provided driver setting flag is OFF (if the determination in step S105 is No), the controller 20 ends the process.

### Procedure of IPP Class Driver Installation Process

Next, a procedure of the IPP class driver installation process will be described with reference to FIGS. 12 to 14.

FIG. 12 is a flowchart illustrating an example of the IPP class driver installation process in the user terminal 2 illustrated in FIG. 1, and corresponds to the process in step S104 in FIG. 11.

In step S201 in FIG. 12, the controller 20 causes the display 24 to display the digital multifunction apparatuses 1 compatible with the installer 26 as PSA plug-in candidates (step S201).

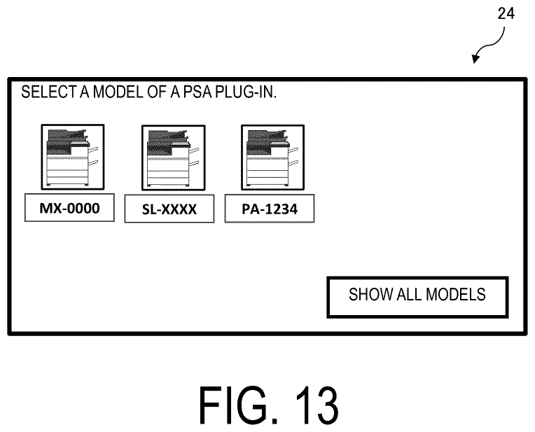

FIG. 13 is an explanatory diagram illustrating an example of candidate models for PSA, which are displayed on the display 24 of the user terminal 2 illustrated in FIG. 1.

In the example in FIG. 13, three candidate models for PSA “MX-0000”, “SL-XXXX”, and “PA-1234” are displayed on the display 24 along with a message “select a model of a PSA plug-in”.

A “show all models”button is also displayed at the lower right of the screen.

Subsequently, in step S202 in FIG. 12, the controller 20 determines whether the digital multifunction apparatus 1 has been selected (step S202).

If the digital multifunction apparatus 1 has not been selected (if the determination in step S202 is No), in step S203, the controller 20 determines whether the “show all models” button has been selected (step S203).

If the “show all models” button has been selected (if the determination in step S203 is Yes), in step S204, the controller 20 causes the display 24 to display all the searched digital multifunction apparatuses 1 (step S204), and then returns the processing to the determination in step S202.

On the other hand, if the “show all models” button has not been selected (if the determination in step S203 is No), the processing returns to the determination in step S202.

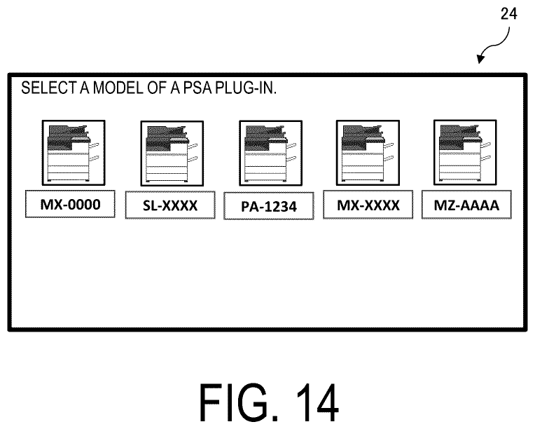

FIG. 14 is an explanatory diagram illustrating an example of all candidate models for PSA, which are displayed on the display 24 of the user terminal 2 illustrated in FIG. 1.

In the example in FIG. 14, all candidate models for PSA “MX-0000”, “SL-XXXX”, “PA-1234”, “MX-XXXX”, and “MZ-AAAA” are displayed on the display 24 along with a message “select a model of a PSA plug-in”.

On the other hand, if a digital multifunction apparatus 1 has been selected in step S202 in FIG. 12 (if the determination in step S202 is Yes), in step S205, the controller 20 requests apparatus identification information from the selected digital multifunction apparatus 1 via the communicator 23 (step S205).

In subsequent step S206, the controller 20 determines whether the communicator 23 has received the apparatus identification information from the digital multifunction apparatus 1 (step S206).

If the communicator 23 has received the apparatus identification information from the digital multifunction apparatus 1 (if the determination in step S206 is Yes), in step S207, the controller 20 causes the storage 21 to store the apparatus identification information and installs the PSA plug-in in the IPP class driver (step S207).

In subsequent step S208, the controller 20 enables the IPP class driver in which the PSA plug-in is installed (step S208), and ends the process.

On the other hand, if the communicator 23 has not received the apparatus identification information from the digital multifunction apparatus 1 (if the determination in step S206 is No), the controller 20 returns the processing to the determination in step S206.

### Procedure of Vendor-provided Driver Installation Process

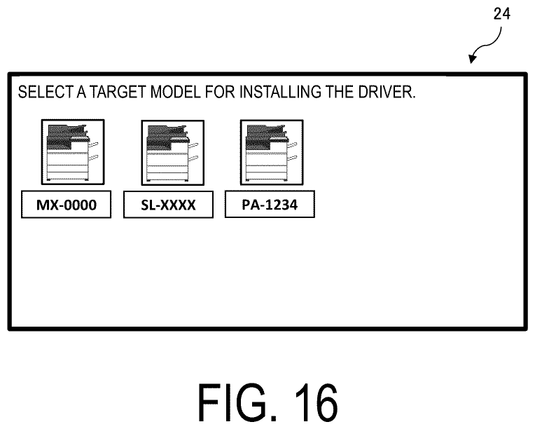

Next, a procedure of the vendor-provided driver installation process will be described with reference to FIGS. 15 and 16.

FIG. 15 is a flowchart illustrating an example of the vendor-provided driver installation process in the user terminal 2 illustrated in FIG. 1, and corresponds to the process in step S106 in FIG. 11.

In step S301 in FIG. 15, the controller 20 causes the display 24 to display the digital multifunction apparatuses 1 compatible with the installer 26 as candidates to be used for setting the vendor-provided driver (step S301).

FIG. 16 is an explanatory diagram illustrating an example of candidate models for the vendor-provided driver, which are displayed on the display 24 of the user terminal 2 illustrated in FIG. 1.

In the example in FIG. 16, three candidate models for vendor-provided driver “MX-0000”, “SL-XXXX”, and “PA-1234” are displayed on the display 24 along with a message “select a target model for installing the driver”.

Subsequently, in step S302 in FIG. 15, the controller 20 determines whether a digital multifunction apparatus 1 has been selected (step S302).

If the digital multifunction apparatus 1 has not been selected (if the determination in step S302 is No), the controller 20 returns the processing to the determination in step S302 (step S302).

On the other hand, if the digital multifunction apparatus 1 has been selected (if the determination in step S302 is Yes), in step S303, the controller 20 requests information to be set in the vendor-provided driver from the selected digital multifunction apparatus 1 via the communicator 23 (step S303).

The settings in the vendor-provided driver include, for example, settings for whether double-sided printing is possible and settings for a punching function.

In subsequent step S304, the controller 20 determines whether the communicator 23 has received the information to be set in the vendor-provided driver from the digital multifunction apparatus 1 (step S304).

If the communicator 23 has received the information to be set in the vendor-provided driver from the digital multifunction apparatus 1 (if the determination in step S304 is Yes), in step S305, the controller 20 causes the storage 21 to store the setting information, and sets the vendor-provided driver, based on the setting information installed in the vendor-provided driver and caused the storage 21 to store (step S305).

In subsequent step S306, the controller 20 enables the installed vendor-provided driver (step S306), and ends the process.

On the other hand, if the communicator 23 has not received the information to be set in the vendor-provided driver from the digital multifunction apparatus 1 (if the determination in step S304 is No), the controller 20 returns the processing to the determination in step S304.

In this way, whether the protected print mode is enabled is determined when the printer driver is installed, and if the protected print mode is enabled, a message is displayed indicating that the printer driver provided by a third party cannot be installed or started, and a setting screen for disabling the protected print mode in order to install and start the printer driver is displayed and the operation by the user is received, thereby achieving the user terminal 2 that is more user-friendly than ever before.

Preferred aspects of the disclosure include any combinations of the multiple aspects described above.

In addition to the aforementioned embodiments, various modifications of the disclosure are possible. It should not be understood that the modifications do not belong to the scope of the disclosure. The disclosure shall include meanings equivalent to the scope of the claims and all modifications within the scope.

1. An electronic device with built-in software capable of installing a printer driver, the electronic device comprising:
an installer that executes an installation process of the printer driver;
a communicator that transmits and receives various data by communicating with an image forming apparatus compatible with the printer driver via a network;
a protected print mode setter that receives a setting of whether a protected print mode predetermined is to be enabled;
a storage that stores the setting;
a display that displays various types of information to a user; and
a controller that controls the installer, the communicator, the protected print mode setter, the storage, and the display,
wherein in a case where the installer is started, the controller determines whether the protected print mode is enabled, and in a case where the protected print mode is enabled, the controller causes the display to display a message indicating that an installation or startup of the printer driver provided by a third party is not possible because the protected print mode is enabled.

2. The electronic device according to claim 1, further comprising:
an operation acceptor that receives operation by a user,
wherein the controller, in the case where the protected print mode is enabled, causes the display to display a message indicating that the protected print mode is to be disabled in order to install and start the printer driver provided by the third party, and a setting screen to disable the protected print mode, and
the operation acceptor receives operation by the user to disable the protected print mode.

3. The electronic device according to claim 1,
wherein the controller, in a case where the protected print mode is enabled, does not permit installation or startup of the printer driver provided by the third party.

4. The electronic device according to claim 1,
wherein the controller, in a case where the protected print mode is disabled, causes the display to display a selection screen of the installable printer driver.

5. The electronic device according to claim 4,
wherein the controller, in the case where the protected print mode is disabled, causes the display to display both the printer driver provided by the third party and an IPP class driver as selectable on the selection screen.

6. The electronic device according to claim 4,
wherein the controller, in the case where the protected print mode is disabled and a plurality of the installable printer drivers are present on the selection screen, causes the display to display a difference in function of the plurality of the installable printer drivers.

7. A method of controlling an electronic device with built-in software capable of installing a printer driver, the method comprising:
transmitting and receiving various data by communicating with an image forming apparatus compatible with the printer driver via a network;
executing an installation process of the printer driver;
receiving a setting of whether a protected print mode predetermined is to be enabled;
storing the setting; and
displaying various types of information to a user,
wherein in a case where the installation process of the printer driver is executed in the executing the installation process, the electronic device determines whether the protected print mode is enabled, and in a case where the protected print mode is enabled, the electronic device displays a message indicating that an installation or startup of the printer driver provided by a third party is not possible because the protected print mode is enabled, in the displaying.
